(19) United States
(12) Patent Application Publication
(10) Pub. No.: US 2010/0117978 A1
(43) Pub. Date: May 13, 2010

(54) APPARATUS AND METHOD FOR TOUCHING BEHAVIOR RECOGNITION, INFORMATION PROCESSING APPARATUS, AND COMPUTER PROGRAM

(76) Inventor: Hirokazu SHIRADO, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/614,756

(22) Filed: Nov. 9, 2009

(30) Foreign Application Priority Data
Nov. 10, 2008 (JP) P2008-287793

(51) Int. Cl. G06F 3/041

(52) U.S. Cl. 345/173

(57) ABSTRACT

A touching behavior recognition apparatus includes a contact point acquiring unit configured to acquire pressure information items and position information items in a plurality of contact points, a clustering unit configured to perform clustering on the contact points on the basis of information regarding pressure deviations and position deviations of the contact points based on the information items acquired by the contact point acquiring unit to form contact point groups each including contact points associated with each other as a touching behavior, and a touching behavior identifying unit configured to identify a touching behavior for each contact point group.

### BACKGROUND OF THE INVENTION

1. Field of the Invention

The present invention relates to touching behavior recognition apparatuses and methods, information processing apparatuses, and computer programs for recognizing a human touching behavior from a plurality of contact points detected through sensors in real time with high accuracy. For example, the present invention relates to a touching behavior recognition apparatus and method, information processing apparatus, and computer program for recognizing the purpose of a human touching behavior performed on a machine, such as a robot, so as to be useful as an interface or nonverbal communication tool for achieving an easy operation of the machine.

More specifically, the present invention relates to a touching behavior recognition apparatus and method, information processing apparatus, and computer program for recognizing a specific touching behavior when a machine comes into contact with surroundings though at least one portion, and in particular, relates to a touching behavior recognizing apparatus and method, information processing apparatus, and computer program for selecting a cluster of contacts of note in a machine which will be in contact with surroundings at all times to recognize a specific touching behavior.

2. Description of the Related Art

Recently, as functions of many machines become complicated, it has been demanded that the machines should be easily operated in response to intuitive instructions. As for operating a machine that involves coming into contact with a user, the inventor has considered that a method for selecting a function directly on the basis of a human touch pattern by utilizing touching behavior recognition is useful as an interface which allows such a machine to be easily operated.

The above-described machine operation based on touch behavior can also be applied to communication through contact with a robot which is active in, for example, daily life, namely, nonverbal communication. This operation is inevitable to establish a flexible and close relationship with the robot.

For the direct and easy machine operation based on touching behavior recognition, it is necessary to recognize a human touching behavior in real time with high accuracy on the basis of a plurality of contact points detected through sensors by the machine.

If the machine operation based on touching behavior recognition is used as a tool for nonverbal communication with a robot, the robot will be in contact with surroundings at all times (in other words, all of contact points are not necessarily based on the same touching behavior). Accordingly, the inventor has considered that it is important to select a cluster of contact points of note from a plurality of contact points and identify the cluster.

For example, it is assumed that a robot is lightly tapped on its shoulder several times while sitting on a chair. So long as the robot ignores contact with the chair, extracts contact information regarding only the contact (tapping) on the shoulder, and identifies “being lightly tapped” on the basis of the contact information, it is difficult for the robot to act normally for smooth interaction with a human being.

There have been few touching behavior recognition systems capable of recognizing a complicated human tactile pattern in real time. For example, there has been proposed a tactile sensor that includes an electrically conductive fabric and is capable of covering the whole body of a robot (refer to Masayuki Inaba, Yukiko Hoshino, Hirochika Inoue, “A Full-Body Tactile Sensor Suit Using Electrically Conductive Fabric”, Journal of the Robotics Society of Japan, Vol. 16, No. 1, pp. 80-86, 1998). Each element of the tactile sensor outputs only two values indicating “being in contact” and “being not in contact”, respectively. Since a human touching manner is determined using only a pattern on a contact surface, it is therefore difficult to perform detailed touching behavior recognition. In addition, one piece of tactile data is processed with respect to the whole body. Accordingly, it is difficult to simultaneously distinguish many kinds of contacts caused by a plurality of external factors.

As another example, there has been proposed a touching behavior discrimination method of performing linear discrimination analysis on nine amounts of feature (hereinafter, referred to as “feature amounts”) obtained from a planar tactile sensor including semiconductor pressure sensor elements as pressure-sensitive elements to discriminate among four touching behaviors of “tapping”, “pinching”, “patting”, and “pushing” with a high discrimination rate (refer to Hidekazu Hirayu, Toshiharu Mukai, “Discrimination of Touching Behaviors with Tactile Sensor”, Technical Reports of Gifu Prefectural Research Institute of Manufacturing Information Technology, Vol. 8, 2007). This method is not performed in real time because a touching behavior is recognized after completion of the behavior. In addition, touching behaviors in a plurality of portions predicted on the application of the sensor to the whole body of a machine, such as a robot, are not taken into consideration in this method. Since the method utilizes linear analysis, only a simple touching behavior pattern is to be discriminated. Disadvantageously, therefore, the method lacks in practicality in terms of the operation of the whole of the machine and interaction.

Furthermore, a touching behavior discrimination apparatus for high-accuracy and real-time processing has been proposed (refer to Japanese Unexamined Patent Application Publication No. 2001-59779). This touching behavior discrimination apparatus is configured to discriminate among five touching behaviors using the k-NN method and the Fisher's linear discriminant on the basis of data previously learned from five feature amounts. In this instance, the five touching behaviors are “slightly tapping”, “scratching”, “patting”, and “tickling”. According to the method, although high-accuracy discrimination can be performed by learning, it is difficult to discriminate typical, continuous and multi-layered human touching behaviors, e.g., “patting while pushing” obtained by classifying feature amounts into categories. Furthermore, since it is necessary to detect a peak value as a feature amount, feature amounts are not extracted unless a series of touching behaviors are finished. In addition, since the sum of feature amounts over the entire contact surface is used, it is difficult to independently determine touching behaviors in a plurality of portions. It is therefore difficult to identify actual complicated touching behavior patterns performed on the whole of a machine.

A communication robot including an input system for recognizing a whole-body tactile image has been proposed (refer to Japanese Unexamined Patent Application Publication No. 2006-123140). This input system performs non-hierarchical clustering on the basis of obtained sensor data to perform hierarchical clustering on the basis of a change in pressure transition at the position of gravity of each cluster, thus identifying a touched portion and a manner of touching. Since a touching behavior is uniquely determined by matching according to the nearest neighborhood method, a continuous and multi-layered complicated touching behavior pattern is not identified in the same case as the above-described touching behavior discrimination apparatus. This communication robot further has the following problems. Since learned data is generated while the position and quality of a touching behavior are confused, indices each indicating which portion of the robot is touched and how the robot is touched are limited. If a plurality of touching behaviors are simultaneously performed on the robot, selection of which touching behavior from among the touching behaviors is not taken into consideration.

Furthermore, there has been proposed a communication robot including an input system for efficiently recognizing a touching behavior (refer to Japanese Unexamined Patent Application Publication No. 2006-281347). This input system performs recognition and compression using wavelet transform on tactile information acquired for each sensor element, thus dispersing processing loads of tactile sensor elements distributed on the whole of the robot. For the application of wavelet transform to touching behavior recognition, it is necessary to store and process data at predetermined time intervals (for example, every one to three seconds in an embodiment). Disadvantageously, real-time capability is not completely taken into consideration. This robot also has the following problem. When a touching behavior is performed over a plurality of sensor elements of the robot, or when touching behaviors are simultaneously performed on the robot, the extent to which any touching behavior is selected is not taken into consideration.

### SUMMARY OF THE INVENTION

It is desirable to provide an excellent touching behavior recognition apparatus and method, information processing apparatus, and computer program which are capable of recognizing a human touching behavior from a plurality of contact points detected through sensors in real time with high accuracy.

It is further desirable to provide an excellent touching behavior recognition apparatus and method, information processing apparatus, and computer program for recognizing the purpose of a human touching behavior performed on a machine, such as a robot, so as to be useful as an interface or nonverbal communication tool for achieving an easy operation of the machine.

It is further desirable to provide an excellent touching behavior recognition apparatus and method, information processing apparatus, and computer program capable of recognizing a specific touching behavior when one or more portions of a machine come into contact with surroundings.

It is further desirable to provide an excellent touching behavior recognition apparatus and method, information processing apparatus, and computer program capable of selecting a cluster of contacts of note in a machine which will be in contact with surroundings at all times to recognize a specific touching behavior.

According to an embodiment of the present invention, a touching behavior recognition apparatus includes a contact point acquiring unit configured to acquire pressure information items and position information items in a plurality of contact points, a clustering unit configured to perform clustering on the contact points on the basis of information regarding pressure deviations and position deviations of the contact points based on the information items acquired by the contact point acquiring unit to form contact point groups each including contact points associated with each other as a touching behavior, and a touching behavior identifying unit configured to identify a touching behavior for each contact point group.

According to this embodiment, the touching behavior identifying unit may include the following elements. A feature amount calculating section is configured to calculate N feature amounts from each contact point group, the feature amounts typifying a contact pattern, N being an integer of three or more. A mapping section is configured to map an N-dimensional feature amount calculated from each contact point group onto an n-dimensional space for each touching behavior class to determine the presence or absence of each touching behavior on the basis of mapped positions in the corresponding space, n being a positive integer less than N. A touching behavior determining section is configured to determine a result of touching behavior recognition on each contact point on the basis of the mapped positions in the n-dimensional space.

According to the embodiment, preferably, the mapping section converts the N-dimensional feature amount calculated from each contact point group into two-dimensional data using a learned hierarchical neural network. More specifically, the mapping section may convert the N-dimensional feature amount calculated from each contact point group into two-dimensional data using a learned self-organizing map.

According to the embodiment, preferably, the mapping section provides the n-dimensional space for each touching behavior class intended to be identified, maps the N-dimensional feature amount calculated from each contact point group onto each of the n-dimensional spaces for the respective touching behavior classes, and determines the presence or absence of each touching behavior on the basis of the mapped positions in the corresponding space, and the touching behavior determining section determines a single result of touching behavior recognition on each contact point group on the basis of transition data indicating results of determination regarding the presence or absence of each touching behavior on each contact point and priorities assigned to the respective touching behavior classes.

According to another embodiment of the present invention, there is provided a method for touching behavior recognition, the method including the steps of acquiring pressure information items and position information items in a plurality of contact points, performing clustering on the contact points on the basis of information regarding pressure deviations and position deviations of the contact points based on the acquired information items to form contact point groups each including contact points associated with each other as a touching behavior, calculating N feature amounts from each contact point group, the feature amounts typifying a contact pattern, N being an integer of three or more, providing an n-dimensional space for each touching behavior class intended to be identified and mapping an N-dimensional feature amount calculated from each contact point group onto each of the n-dimensional spaces for the respective touching behavior classes to determine the presence or absence of each touching behavior on the basis of mapped positions in the corresponding space, n being a positive integer less than N, and determining a single result of touching behavior recognition on each contact point group on the basis of transition data indicating results of determination regarding the presence or absence of each touching behavior on each contact point and priorities assigned to the respective touching behavior classes.

According to another embodiment of the present invention, there is provided an information processing apparatus for performing information processing in accordance with a user operation. The apparatus includes a contact point detecting unit including tactile sensor groups attached to the main body of the information processing apparatus, the unit being configured to detect pressure information items and position information items in a plurality of contact points, a clustering unit configured to perform clustering on the contact points on the basis of information regarding pressure deviations and position deviations of the contact points based on the information items detected by the contact point detecting unit to form contact point groups each including contact points associated with each other as a touching behavior, a feature amount calculating unit configured to calculate N feature amounts from each contact point group, the feature amounts typifying a contact pattern, N being an integer of three or more, a mapping unit configured to provide an n-dimensional space for each touching behavior class intended to be identified, map an N-dimensional feature amount calculated from each contact point group onto each of the n-dimensional spaces for the respective touching behavior classes, and determine the presence or absence of each touching behavior on the basis of mapped positions in the corresponding space, a touching behavior determining unit configured to determine a single result of touching behavior recognition on each contact point group on the basis of transition data indicating results of determination regarding the presence or absence of each touching behavior on each contact point and priorities assigned to the respective touching behavior classes, and a control unit configured to control information processing on the basis of the result of touching behavior recognition determined by the touching behavior determining unit.

According to another embodiment of the present invention, there is provided a computer program described in computer-readable form so as to allow a computer to execute a process for recognizing a human touching behavior, the computer program allowing the computer to function as a contact point acquiring unit configured to acquire pressure information items and position information items in a plurality of contact points, a clustering unit configured to perform clustering on the contact points on the basis of information regarding pressure deviations and position deviations of the contact points based on the information items acquired by the contact point acquiring unit to form contact point groups each including contact points associated with each other as a touching behavior, a feature amount calculating unit configured to calculate N feature amounts from each contact point group, the feature amounts typifying a contact pattern, N being an integer of three or more, a mapping unit configured to provide an n-dimensional space for each touching behavior class intended to be identified, map an N-dimensional feature amount calculated from each contact point group onto each of the n-dimensional spaces for the respective touching behavior classes, and determine the presence or absence of each touching behavior on the basis of mapped positions in the corresponding space, a touching behavior determining unit configured to determine a single result of touching behavior recognition on each contact point group on the basis of transition data indicating results of determination regarding the presence or absence of each touching behavior on each contact point and priorities assigned to the respective touching behavior classes.

The computer program according the above-described embodiment is defined as a computer program described in computer-readable form so as to achieve a predetermined process on a computer. In other words, the computer program according to the above-described embodiment is installed into a computer, so that a cooperative operation is achieved on the computer. Thus, the same operations and advantages as those of the touching behavior recognition apparatus according to the foregoing embodiment can be obtained.

According to the embodiments of the present invention, there can be provided an excellent touching behavior recognition apparatus and method, information processing apparatus, and computer program capable of recognizing a human touching behavior from a plurality of contact points detected through sensors in real time with high accuracy.

According to the embodiments of the present invention, there can be provided an excellent touching behavior recognition apparatus and method, information processing apparatus, and computer program capable of selecting a cluster of contacts of note in a machine which will be in contact with surroundings at all times to recognize a specific touching behavior. The touching behavior recognition apparatus according to the embodiment of the present invention is capable of recognizing the purpose of a human touching behavior performed on a machine, such as a robot in real time with high accuracy. Accordingly, the apparatus is useful as an interface or nonverbal communication tool for achieving an easy operation of the machine.

According to the above-described embodiments, touching behavior recognition is performed on each contact point group. Accordingly, even when different kinds of touching behaviors are simultaneously performed in different portions, the touching behaviors can be individually recognized.

According to the above-described embodiments, since the mapping unit (section) maps an N-dimensional feature amount calculated from each contact point group onto each lower dimensional space, namely, performs dimensional compression, high-speed and high-accuracy touching behavior recognition can be performed.

According to the above-described embodiments, since a touching behavior is identified using a self-organizing map, flexible determination which is not a rule-based determination like threshold determination can be achieved.

According to the above-described embodiments, since identification is performed using a plurality of self-organizing maps for respective touching behaviors intended to be identified, the inclusion relationship between the touching behaviors can be taken into consideration. Accordingly, multi-layered recognition of layered touching behavior classes, such as “patting while pushing”, and context-dependent recognition can be performed.

According to the above-described embodiments, a result of identification at certain time is determined by comparing with a result of past identification and is output as a minimum result of touching behavior recognition. Thus, a context-dependent result can be obtained. On the other hand, a physical quantity acquired that instant is used as a feature amount, serving as a base for identification, a result of identification can be obtained in real time.

Other features and advantages of the present invention will become more apparent from the following detailed description of preferred embodiments of the invention in conduction with the accompanying drawings.

### BRIEF DESCRIPTION OF THE DRAWINGS

FIG. 1 illustrates the appearance configuration of a humanoid robot to which the present invention is applicable;

FIG. 2 illustrates the configuration of a tactile sensor group;

FIG. 3 is a diagram schematically illustrating the configuration of a tactile sensor CS;

FIG. 4 is a diagram illustrating an exemplary topology of the robot shown in FIG. 1;

FIG. 5 is a diagram illustrating the configuration of a control system of the robot in FIG. 1;

FIG. 6 is a diagram schematically illustrating the functional configuration of a touching behavior recognition apparatus according to an embodiment of the present invention;

FIG. 7 is a diagram explaining a process performed by a clustering unit;

FIG. 8 is a diagram illustrating a hierarchy of clusters;

FIG. 9 is a diagram illustrating an exemplary structure of a self-organizing map;

FIG. 10 is a diagram explaining a mechanism in which a touching behavior determining section performs data processing on a plurality of self-organizing maps provided for touching behavior classes;

FIG. 11 is a flowchart of a process for determining a touching behavior on the basis of results of determination regarding the presence or absence of each touching behavior by the touching behavior determining section; and

FIG. 12 is a diagram illustrating a situation in which a user operates a touch panel personal digital assistant (PDA) through touching behaviors, i.e., by touching the PDA with fingertips.

### DESCRIPTION OF THE PREFERRED EMBODIMENTS

Embodiments of the present invention will be described below with reference to the drawings.

An application of a touching behavior recognition apparatus according to an embodiment of the present invention relates to a nonverbal communication tool of a robot. In the robot, tactile sensor groups are attached to various portions which will come into contact with surroundings.

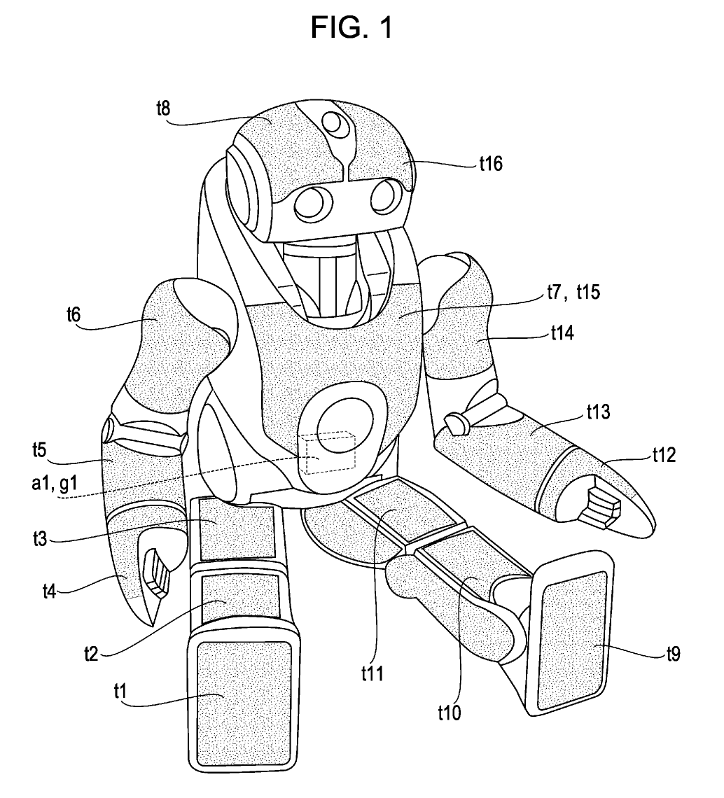

FIG. 1 illustrates the appearance configuration of a humanoid robot to which the present invention is applicable. Referring to FIG. 1, the robot is constructed such that a pelvis is connected to two legs, serving as transporting sections, and is also connected through a waist joint to an upper body. The upper body is connected to two arms and is also connected through a neck joint to a head.

The right and left legs each have three degrees of freedom in a hip joint, one degree of freedom in a knee, and two degrees of freedom in an ankle, namely, six degrees of freedom in total. The right and left arms each have three degrees of freedom in a shoulder, one degree of freedom in an elbow, and two degrees of freedom in a wrist, namely, six degrees of freedom in total. The neck joint and the waist joint each have three degrees of freedom about the X, Y, and Z axes.

An actuator driving each joint shaft includes, for example, a brushless DC motor, a speed reducer, and a position sensor that detects the rotational position of an output shaft of the speed reducer. These joint actuators are connected to a host computer that performs centralized control of operations of the whole humanoid robot. It is assumed that each actuator can receive a position control target value from the host computer and also can transmit data indicating the current angle of the corresponding joint (hereinafter, referred to as the “current joint angle”) or the current angular velocity thereof (hereinafter, referred to as the “current joint angular velocity”) to the host computer.

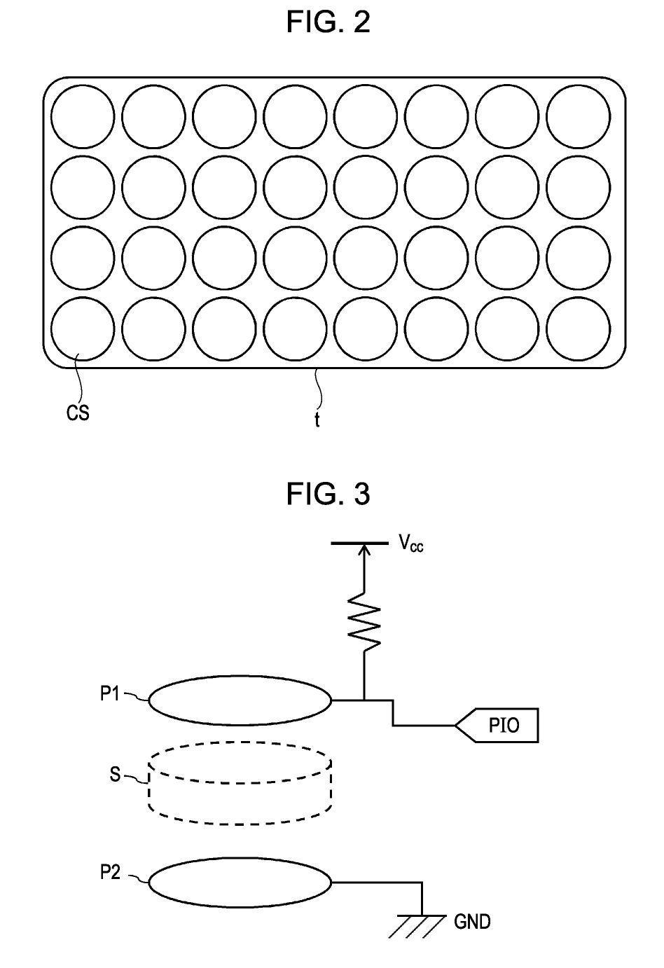

On the surface of the robot shown in FIG. 1, tactile sensor groups t1, t2, . . . , and t16 are attached to the respective portions which will come into contact with surroundings. FIG. 2 illustrates the configuration of each tactile sensor group. Referring to FIG. 2, the tactile sensor group t includes an array of tactile sensors CS capable of independently detecting a contact state. The tactile sensor group t can determine which tactile sensor CS is in the contact state to specify a detailed contact position.

FIG. 3 schematically illustrates the configuration of the tactile sensor CS. The tactile sensor CS includes two electrode plates P1 and P2 with a space S therebetween. A potential V_{cc} is applied to the electrode plate P1. The other electrode plate P2 is grounded. The electrode plate P1 is connected to a microcomputer via a parallel interface (PIO), thus determining whether the electrode plate is in contact with the other one, namely, an external force is applied to the tactile sensor CS. The scope of the present invention is not limited to the configuration of a specific tactile sensor.

One microcomputer is placed in the vicinity of each tactile sensor group t so as to receive detection signals output from all of the tactile sensors CS constituting the tactile sensor group, collect pieces of data (hereinafter, referred to as “data items”) indicating ON/OFF states of the respective tactile sensors, and transmit data indicating whether the corresponding portion is in contact with surroundings and, so long as the portion is in contact therewith, data indicating a contact position to the host computer.

Referring again to FIG. 1, the pelvis of the robot is provided with a three-axis acceleration sensor a1 and a three-axis angular velocity sensor (gyro) g1. In the vicinity of these sensors, a microcomputer measuring values of the sensors is placed to transmit results of measurement (hereinafter, also referred to as “measurement results”) to the host computer.

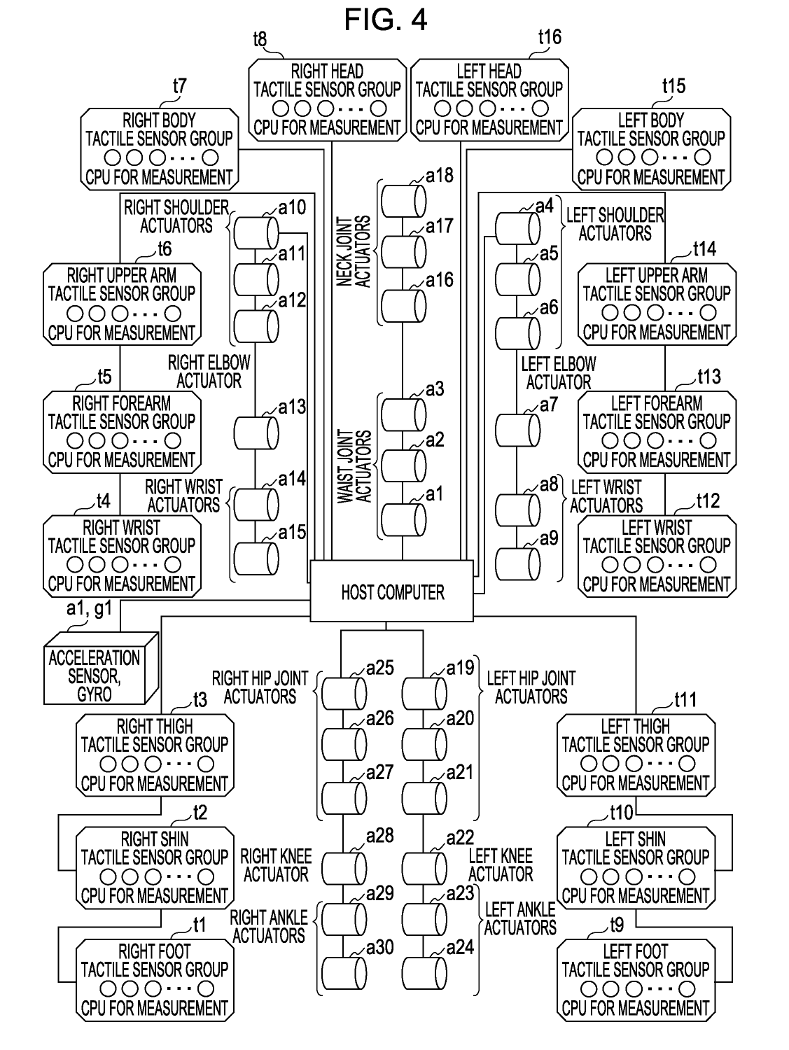

FIG. 4 illustrates an exemplary topology of the robot in FIG. 1.

The robot includes, in the body, three-axis waist joint actuators a1, a2, and a3, three-axis neck joint actuators a16, a17, and a18. These actuators are connected in series to the host computer. Each joint actuator receives a position control target value from the host computer through a serial cable and also transmits the current output torque, joint angle, and joint angular velocity to the host computer.

The robot further includes, in the left arm, three-axis shoulder actuators a4, a5, and a6, a single-axis elbow actuator a7, and two-axis wrist actuators a8 and a9. These actuators are connected in series to the host computer. Similarly, the robot includes, in the right arm, three-axis shoulder actuators a10, a11, and a12, a single-axis elbow actuator a13, and two-axis wrist actuators a14 and a15. These actuators are connected in series to the host computer.

In addition, the robot includes, in the left leg, three-axis hip joint actuators a19, a20, and a21, a single-axis knee actuator a22, and two-axis ankle actuators a23 and a24. These actuators are connected in series to the host computer. Similarly, the robot includes, in the right leg, three-axis hip joint actuators a25, a26, and a27, a single-axis knee actuator a28, and two-axis ankle actuators a29 and a30. These actuators are connected in series to the host computer.

Each of the actuators a1 to a30 used in the respective joints includes, for example, a brushless DC motor, a speed reducer, a position sensor that detects the rotational position of an output shaft of the speed reducer, and a torque sensor. The actuator rotates in accordance with a position control target value supplied externally and outputs the current output torque, joint angle, and joint angular velocity. The above-described type of joint actuators are disclosed in, for example, Japanese Unexamined Patent Application Publication No. 2004-181613 assigned to the same assignee.

Furthermore, in the right leg of the robot, the right foot tactile sensor group t1, the right shin tactile sensor group t2, and the right thigh tactile sensor group t3 are arranged. These tactile sensor groups are connected in series to the host computer. Each of the tactile sensor groups t1 to t3 is provided with the microcomputer, as described above. Each microcomputer collects data items indicating ON/OFF states of the tactile sensors CS in the corresponding tactile sensor group and transmits the data items to the host computer via the serial cable. Similarly, in the left leg of the robot, the left foot tactile sensor group t9, the left shin tactile sensor group t10, and the left thigh tactile sensor group t11 are arranged. The microcomputer, provided for each tactile sensor group, collects data items indicating ON/OFF states of the tactile sensors CS in the tactile sensor group and transmits the data items to the host computer via the serial cable.

In addition, in the right arm of the robot, the right wrist tactile sensor group t4, the right forearm tactile sensor group t5, and the right upper arm tactile sensor group t6 are arranged. The microcomputer, provided for each tactile sensor group, collects data items indicating ON/OFF states of the tactile sensors CS in the tactile sensor group and transmits the data items to the host computer via the serial cable. Similarly, in the left arm of the robot, the left wrist tactile sensor group t12, the left forearm tactile sensor group t13, and the left upper arm tactile sensor group t14 are arranged. The microcomputer, provided for each tactile sensor group, collects data items indicating ON/OFF states of the tactile sensors CS in the tactile sensor group and transmits the data items to the host computer via the serial cable.

Furthermore, the body tactile sensor groups t7 and t15 are attached to right and left portions of the body of the robot. The microcomputer, provided for each tactile sensor group, collects data items indicating ON/OFF states of the tactile sensors CS in the tactile sensor group and transmits the data items to the host computer via the serial cable.

In addition, the head tactile sensor groups t8 and t16 are attached to the right and left portions of the head of the robot. The microcomputer, provided for each tactile sensor group, collects data items indicating ON/OFF states of the tactile sensors CS in the tactile sensor group and transmits the data items to the host computer via the serial cable.

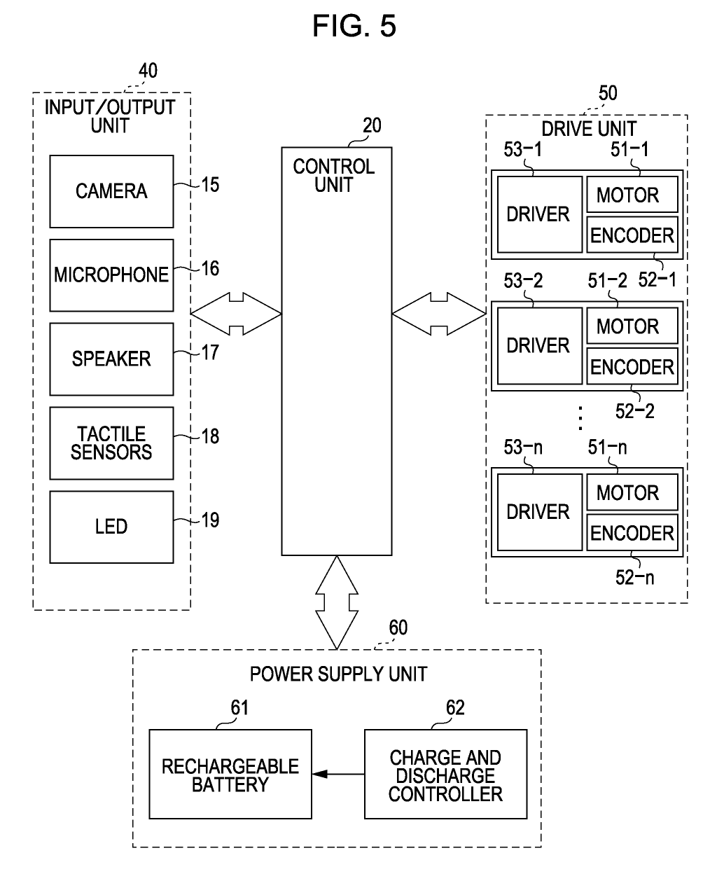

FIG. 5 illustrates the configuration of a control system of the robot shown in FIG. 1. The control system includes a control unit 20 that performs centralized control of operations of the whole robot and data processing, an input/output unit 40, a drive unit 50, and a power supply unit 60. The respective components will be described below.

The input/output unit 40 includes a charge coupled device (CCD) camera 15 corresponding to an eye, a microphone 16 corresponding to an ear, and tactile sensors 18 (corresponding to the tactile sensor groups t1, t2, . . . , and t16 in FIG. 1) arranged in respective portions which will come into contact with surroundings. These components constitute an input section of the robot. The input/output unit 40 may include other various sensors corresponding to the five senses. The input/output unit 40 further includes a speaker 17 corresponding to a mouth and an LED indicator (eye lamp) 19 that produces a facial expression using a combination of ON and OFF states or timing of turn-on. The components 17 and 19 constitutes an output section of the robot. In this case, the input devices, namely, the CCD camera 15, the microphone 16, and the tactile sensors 18 each perform analog-to-digital conversion on a detection signal and digital signal processing.

The drive unit 50 is a functional module for achieving the degrees of freedom about the roll, pitch, and yaw axes of the respective joints of the robot. The drive unit 50 includes drive elements each including a motor 51 (corresponding to any of the actuators a1, a2, . . . in FIG. 4), an encoder 52 that detects the rotational position of the motor 51, and a driver 53 that appropriately controls the rotational position and/or rotational speed of the motor 51 on the basis of an output of the encoder 52. The robot can be constructed as a legged mobile robot, such as a bipedal or quadrupedal walking robot, depending on how the drive units are combined.

The power supply unit 60 is a functional module that literally supplies electric power to electric circuits in the robot. In this case shown in FIG. 5, the power supply unit 60 is of an autonomous driving type using a battery. The power supply unit 60 includes a rechargeable battery 61 and a charge and discharge controller 62 that controls charge and discharge states of the rechargeable battery.

The control unit 20 corresponds to the “brain” and is installed in, for example, a head unit or a body unit of the robot. The control unit 20 implements, for example, an operation control program for controlling a behavior in accordance with a result of recognition of an external stimulus or a change in internal state. A method of controlling a behavior of a robot in accordance with a result of recognition of an external stimulus or a change in internal state is disclosed in Japanese Patent No. 3558222 assigned to the same assignee as this application.

An example of the external stimulus is a touching behavior performed on the surface of the robot by a user. Touching behaviors can be detected though the tactile sensor groups t1, t2, . . . , and t16.

Although the robot shown in FIG. 1 will be in contact with surroundings at all times, all of contact points are not necessarily based on the same touching behavior. Accordingly, the touching behavior recognition apparatus according to the present embodiment selects a cluster of contact points of note from among contact points to recognize a human touching behavior for each cluster in real time with high accuracy.

To recognize touching behaviors in a plurality of portions, first, the touching behavior recognition apparatus according to the present embodiment performs clustering on the basis of information regarding pressure deviations and position deviations of respective contact points to form groups of contact points (hereinafter, referred to as “contact point groups”), each group including contact points associated with each other as a touching behavior. Subsequently, the apparatus calculates a plurality of physical quantities considered to typify a contact pattern from each contact point group. In this specification, a physical quantity typifying a contact pattern is called a “feature amount”. In order not to deteriorate the real-time capability of identification, a peak value determined at the completion of a touching behavior is not used as a feature amount.

The touching behavior recognition apparatus converts a calculated multidimensional feature amount into two-dimensional data, namely, performs dimensional compression using a learned self-organizing map and associates a touching behavior with mapped positions in the self-organizing map on which the feature amounts of each contact point group are mapped.

In this specification, classes of touching behaviors, such as “tapping”, “pinching”, “patting”, “pushing”, and the like are called “touching behavior classes”. The number of touching behaviors performed by a human being for a certain period of time is not limited to one. Such touching behaviors, for example, “patting while pressing” have continuity and a multi-layered relationship (or inclusion relationship) therebetween.

To take the continuity and multi-layered relationship of touching behaviors into consideration, the touching behavior recognition apparatus according to the present embodiment prepares self-organizing maps equal in number to touching behavior classes intended to be identified, and determines the presence or absence of each touching behavior class in each mapped position every step to obtain binarized results of determination (hereinafter, referred to as “determination results”). In other words, whether each of the touching behaviors of the touching behavior classes is recognized (hereinafter, referred to as “the presence or absence of each touching behavior”) is determined on each contact point group. Multidimensional feature amounts of the respective touching behaviors are not necessarily orthogonal to one another, so that it is difficult to completely separate the touching behaviors. In some cases, therefore, when a certain contact point group is mapped onto the self-organizing maps of the touching behavior classes, the “presence” of two or more touching behavior classes is determined. Identifying a touching behavior using the self-organizing maps allows for flexible determination which is not a rule-based determination like threshold determination.

After the determination results regarding the presence or absence of the touching behaviors are obtained on the basis of each multidimensional feature amount (i.e., each contact point group) as described above, the touching behavior recognition apparatus can finally obtain a result of touching behavior recognition unique to each multidimensional feature amount (i.e., each contact point group) every step on the basis of transition data items regarding the determination results and priorities assigned to the respective touching behavior classes. When a plurality of touching behaviors are recognized with respect to a certain contact point group, one touching behavior can be selected from among the touching behaviors on the basis of information supplied from another function, such as an attention module.

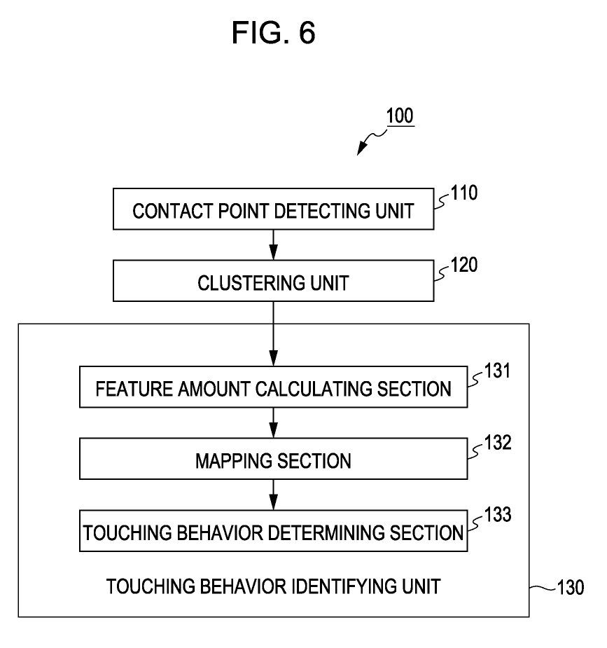

FIG. 6 schematically illustrates the functional configuration of a touching behavior recognition apparatus 100 according to an embodiment of the present invention. The touching behavior recognition apparatus 100 is configured as dedicated hardware. Alternatively, the touching behavior recognition apparatus 100 can be realized in the form of a program that is implemented on a computer. A result of recognition by the touching behavior recognition apparatus 100 is supplied as a result of recognition of, for example, an external stimulus to the operation control program.

A contact point detecting unit 110 includes a plurality of tactile sensor groups (corresponding to the tactile sensor groups t1, t2, . . . , and t16 in FIG. 1) and acquires pressure information and position information in each of a plurality of contact points. Specifically, the contact point detecting unit 110 receives from the input/output unit 40, as digital values, pressure information items and position information items in the contact points detected through the tactile sensors 18 arranged in the respective portions which will come into contact with surroundings.

A clustering unit 120 performs clustering on the basis of information regarding pressure deviations and position deviations of the detected contact points to form contact point groups in each of which the contact points are associated with each other as a touching behavior.

A touching behavior identifying unit 130 includes a feature amount calculating section 131, a mapping section 132, and a touching behavior determining section 133.

The feature amount calculating section 131 calculates a multidimensional physical quantity considered to typify a contact pattern from each contact point group.

The mapping section 132 prepares a two-dimensional self-organizing map for each touching behavior class intended to be identified, and maps an N-dimensional feature amount calculated from each contact point group onto the self-organizing maps for the touching behavior classes. After that, the mapping section 132 determines the presence or absence of each touching behavior class on the basis of mapped positions in the corresponding self-organizing map.

The touching behavior determining section 133 determines a result of touching behavior recognition unique to each contact point group on the basis of transition data indicating the determination results regarding the presence or absence of each touching behavior on each contact point and the priorities assigned to the touching behavior classes. The touching behavior recognition result is supplied as an external stimulus to, for example, the operation control program of the robot.

Processes in the respective functional modules in the touching behavior recognition apparatus 100 will now be described in detail.

In order to recognize touching behaviors using a plurality of contact points detected by the contact point detecting unit 110, the clustering unit 120 has to perform clustering on the contact points, specifically, form contact point groups in each of which the contact points are associated with each other as a touching behavior. Because touching behavior recognition is performed for each contact point group. Many of related-art touching behavior recognition techniques are classified into two types, i.e., a first type of recognition using a single contact point and a second type of recognition using a single group of contact points. On the contrary, according to the present embodiment of the present invention, it should be appreciated that a plurality of contact point groups are simultaneously handled to recognize touching behaviors for the respective contact point groups at the same time.

To cluster contact points detected for a certain control period as a group of contact points associated with each other as a touching behavior, the contact points have to be identified as those detected previously. The reason is as follows. When only information regarding the contact points detected for such a certain control period is used, it is not clear that the contact points relate to a series of touching behaviors continued from a first previous control period or relate to a new touching behavior. Unfortunately, it is difficult to cluster the contact points. Particularly, in the use of deviations (position deviation information and pressure deviation information) from data of the past as feature amounts upon clustering, it is inevitable to identify the relation between the currently detected contact points and the previously detected contact points.

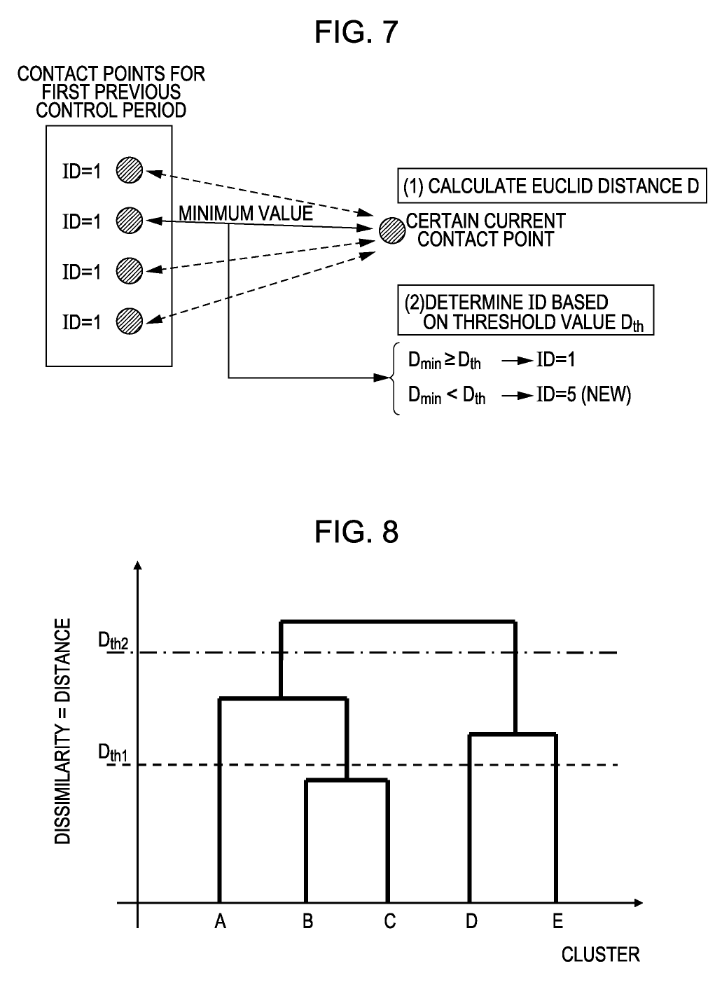

In the present embodiment, a process of contact points in a series of touching behaviors is regarded as to have the Markov property. The Markov property means that hypothetical future states depend only on the present state, as is recognized. First, the clustering unit 120 calculates a geometrical Euclid distance D between a contact point measured for a certain control period and each of contact points measured for the previous period. When a minimum value Dₘᵢₙ does not exceed a threshold value Dₜₕ, the clustering unit 120 estimates that the contact point is the same as that measured for the previous period and assigns the contact point the same ID as that of the previously measured contact point. When the minimum value Dₘᵢₙ exceeds the threshold value Dₜₕ, the clustering unit 120 estimates the contact point as a new one and assigns a new ID to the contact point (refer to FIG. 7).

Subsequently, the clustering unit 120 performs cluster analysis on each contact point to form a group of contact points associated with each other as a touching behavior. In the present embodiment, on the assumption that a touching behavior pattern is broadly marked by a change in positions of contact points and a change in pressures in the contact points, a deviation in position of each contact point and a deviation in pressure in the contact point are used as feature amounts indicating a relation to a touching behavior.

One of clustering methods is, for example, a method of performing hierarchical cluster analysis and setting a threshold value for dissimilarities to form a cluster. Assuming that M contact points are input for a certain control period, an initial state in which there are clusters and a cluster includes only one of the M contact points is first produced. Subsequently, a distance D(Cₗ, C₂) between clusters is calculated from a distance D(xₗ, x₂) between feature amount vectors xₗ and x₂ of the contact point. Two closest clusters are merged sequentially. D(Cₗ, C₂), indicating a distance function representing the dissimilarity of the two clusters C₁ and C₂, can be obtained by using, for example, Ward's method, as expressed by the following expression.

D(C₁,C₂)=E(C₁∪C₂)−E(C₁)−E(C₂) where, E(C₁)=Σ_{xεC}_{ᵢ}(D(x,Cᵢ))² (1)

In Expression (1), x denotes a feature amount vector having, as elements, a position deviation and a pressure deviation in the contact point. E(Cᵢ) is the sum of squares of the distances between the centroid (center of gravity) of the ith cluster Cᵢ and respective contact points x included in the cluster Cᵢ. The distance D(C₁, C₂) calculated using Ward's method is a result obtained by subtracting the sum of squares of the distances between the centroid of the cluster C₁ and respective contact points therein and the sum of squares of the distances between the centroid of the cluster C₂ and respective contact points therein from the sum of squares of the distances between the centroid of the merged cluster of the two clusters C₁ and C₂ and respective contact points in the merged cluster. The higher the similarity of the clusters C₁ and C₂, the shorter the distance D(C₁, C₂). Ward's method exhibits higher sensitivity of classification than other distance functions because the distances between the centroid of a cluster and respective contact points therein are minimized.

Such a process of sequentially merging two close clusters is repeated until a single cluster contains all of contact points, so that a hierarchy of clusters can be formed. The hierarchy is expressed as a binary tree structure, called a dendrogram. FIG. 8 illustrates a hierarchy of clusters A to E represented in a binary tree structure. In FIG. 8, the axis of ordinates corresponds to a distance in Ward's method, namely, dissimilarity. It will be understood that the relationship between contact points is expressed as a dissimilarity. When a distance or dissimilarity threshold value is set, contact points with high similarities are grouped into a cluster, i.e., a contact point group on the basis of feature amount vectors of the contact points. Furthermore, raising or reducing a threshold value can control the number of contact point groups to be obtained. Referring to FIG. 8, using a threshold value Dₜₕ₁ yields four clusters, namely, {A}, {B, C}, {D}, and {E}. Using a threshold value Dₜₕ₂ yields two contact point groups {A, B, C} and {D, E}.

When there are many contact points, a tree structure is complicated. Accordingly, the k-means method, serving as nonhierarchical cluster analysis, or the ISODATA method is also useful.

The feature amount calculating section 131 calculates a plurality of feature amounts, i.e., an N-dimensional feature amount typifying a contact pattern (i.e., for touching behavior recognition) from each contact point group formed by the above-described hierarchical cluster analysis.

Feature amounts for touching behavior recognition include, for example, the following physical quantities. Any physical quantity can be obtained from position information and pressure information output from a tactile sensor group.

Contact points included in a contact point group

Mean normal force in a contact point included in the contact point group

Sum of opposed components of a force applied to each contact point included in the contact point group, the components being obtained by resolving the force at rectangular coordinate axes

Sum of tangential forces in contact points included in the contact point group

Mean of moving speeds of contact points included in the contact point group

Time during which a normal force in a contact point, included in the contact point group, continues exceeding a threshold value

Time during which a normal force in a contact point, included in the contact point group, continues acting in a predetermined direction

Determination as to whether the same portion has been again touched in a single touching behavior

As for a physical quantity used as a feature amount for touching behavior recognition, a physical quantity which can be calculated when a contact point is detected is used in terms of real-time capability for recognition.

In the present embodiment, five classes of “tapping”, “pushing”, “patting”, “gripping”, and “pulling” are considered as touching behaviors intended to be identified. In the present embodiment, “tapping” is defined as a behavior of forming an impulse pattern in which a large pressure is generated for a short time, “pushing” is defined as a behavior of applying a relatively large pressure in a predetermined direction while being in contact for a long time, “patting” is defined as a behavior of repetitively coming into contact with the same portion while the position of contact is being parallel-shifted on the contact surface within a predetermined speed range, “gripping” is defined as a behavior in which opposing normal forces each having a certain level of magnitude are maintained for a long time, and “pulling” is a behavior in which the tangential force of the normal forces of “gripping” acts in a predetermined direction in addition to the “gripping” action.

In the present embodiment, the above-described eight physical quantities are used as physical quantities capable of typifying the above-described defined touching behaviors and distinguishing the touching behaviors from one another. The following table illustrates the relationship between the touching behavior classes and the physical quantities considered to typify the touching behavior classes.

TABLE 1

| Touching | |
|---|---|
| Behavior Class | Feature Amount |
| Tapping | Mean Normal Force |
| Pushing | Time during which a normal force |
| | continues exceeding a threshold value |
| Patting | Total tangential force, Mean moving |
| | speed, Determination as to whether the |
| | same portion has been touched again |
| Gripping | Number of contact points, Total force |
| | of opposing components |
| Pulling | Total tangential force, Time during |
| | which the tangential force continues |
| | acting in a predetermined direction |

The scope of the present invention is not limited to the above-described feature amounts. A physical quantity related to each touching behavior class has no simple relation therewith. Accordingly, it is difficult to represent a touching behavior pattern using related physical quantities. To perform high-speed and high-accuracy recognition, it is therefore necessary to use a data mining technique, such as dimensional compression, which will be described below.

The mapping section 132 compresses the eight-dimensional feature amount vector calculated from each contact point group into two-dimensional information using a learned hierarchical neural network. More specifically, the mapping section 132 compresses the eight-dimensional feature amount vector calculated from each contact point group into two-dimensional information using the self-organizing maps.

In this instance, the self-organizing map (SOM) is a kind of two-layered feed-forward neural networks. In the use of the self-organizing map, multidimensional data is two-dimensionally mapped so that a higher dimensional space can be visualized. The self-organizing map can be used for classification of multidimensional data, feature extraction, and pattern recognition.

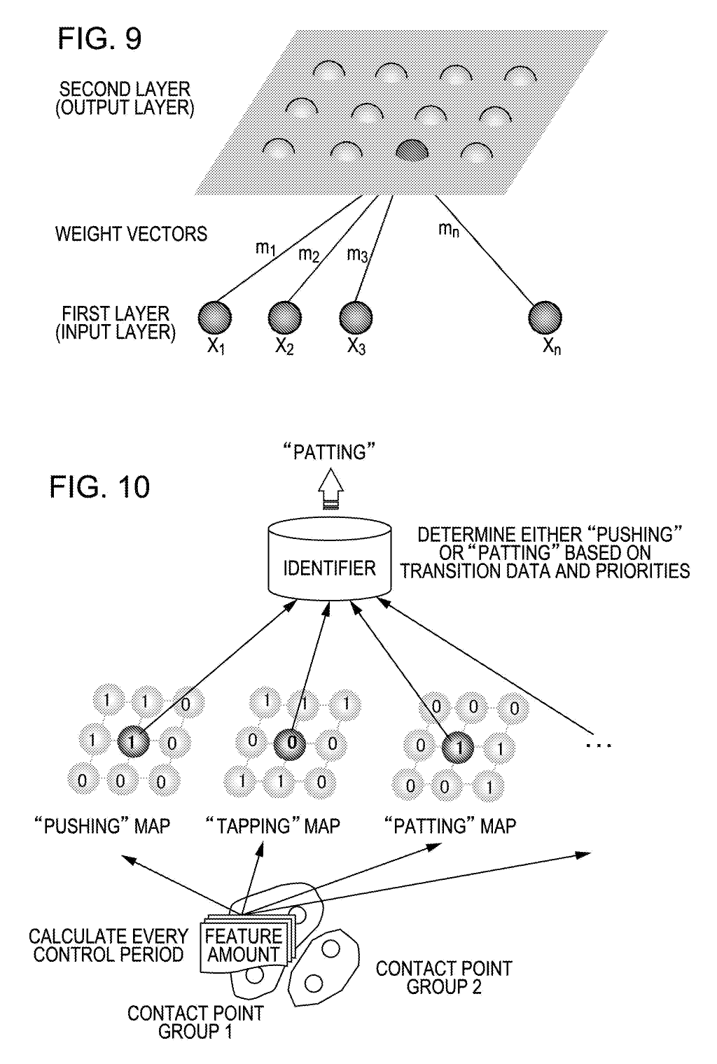

FIG. 9 schematically shows the structure of a self-organizing map. Referring to FIG. 9, the self-organizing map includes n-dimensional input layers X₁, X₂, X, each of which serves as a first layer, and a competitive layer serving as a second layer. Usually, the second layer is expressed in a dimension less than that of the input layers and often includes a two-dimensional array because of the ease of visual recognition. The competitive layer as the second layer is expressed using weight vectors mₗ, m₂, . . . , and mₙ and includes n elements equal in number to those in the n-dimensional input layers.

Learning with the self-organizing map is a kind of unsupervised competitive learning techniques for obtaining firing of only one output neuron and uses a Euclid distance for learning. First, all of weight vectors mᵢ are determined at random. When an input vector is given as data to be learned, the second layer as the output layer of the self-organizing map is searched for a node (neuron) at which the Euclid distance between the input vector and any of the weight vectors is minimized and the node closest to the input vector is determined as the most appropriately matched winner node.

Subsequently, the weight vector at the winner node is updated so as to approach the input vector as the learned data. In addition, the weight vectors at nodes in the neighborhood of the winner node are updated so as to slightly approach the learned data, thus learning the input vector. In this instance, the range of neighborhood and an amount of update are determined by neighborhood function. The range of neighborhood decreases as learning time elapses. Consequently, as the learning time elapses, the nodes with the weight vectors similar to the input vector are positioned closer to each other and the other nodes with the weight vectors dissimilar to the input vector are positioned farther away in the output layer. Accordingly, the nodes with the weight vectors similar to respective input vectors gather in the output layer as if to form a map corresponding to a pattern included in learned data.

The above-described learning process in which similar nodes gather to geometrically close positions as the learning progresses to form a map included in learned data is called “self-organizing learning”. In the present embodiment, it is assumed that the self-organizing maps used in the mapping section 132 are learned by batch learning. The batch learning is a method for initially reading all of data items to be learned in order to simultaneously learn the data items. The batch learning method differs from the sequential learning method for reading data items to be learned one by one to update node values in a map. The batch learning method allows for formation of a map which does not depend on the order of learned data items.

The self-organizing map, proposed by Teuvo Kohonen, is a neural network obtained by modeling neurological functions of the cerebral cortex. For details of the self-organizing maps, for example, refer to T. Kohonen, “Jiko Soshikika Mappu [Self-Organizing Maps]” translated by Heizo Tokutaka, Satoru Kishida, and Kikuo Fujimura, Springer Verlag Tokyo, first published on Jun. 15, 1996.

For touching behaviors intended to be identified, the five classes of “tapping”, “pushing”, “patting”, “gripping”, and “pulling” are considered (refer to the above description and Table 1). In this case, learned data items are measured several times for each of the touching behavior classes, so that self-organizing maps for simultaneously identifying all of the classes can be formed on the basis of the results of measurement. As for human touching behaviors, however, a plurality of touching behaviors are often performed together in a multi-layered manner. One example is “patting while pushing”. Furthermore, since feature amounts of the respective touching behavior classes are not completely orthogonal to each other, the feature amounts are not separated from each other in a single self-organizing map. Accordingly, there are problems in that multi-layered recognition and context-dependent recognition are not performed in a single self-organizing map for simultaneously recognizing all of the classes to be identified.

According to the present embodiment, a self-organizing map is formed for each touching behavior class intended to be identified and a plurality of self-organizing maps for the respective touching behavior classes are prepared in the mapping section 132. When supplied with an eight-dimensional feature amount calculated from a certain contact point group, the mapping section 132 maps the eight-dimensional feature amount onto each self-organizing map to determine the presence or absence of each touching behavior on the basis of mapped positions on the corresponding self-organizing map. As for multi-layered touching behaviors, such as “patting while pushing”, in which a plurality of touching behavior classes are performed simultaneously, therefore, the touching behavior determining section 133 can perform multi-layered recognition regarding “pushing” and “patting” using the relevant self-organizing maps.

FIG. 10 illustrates a mechanism in which the touching behavior determining section 133 performs data processing on the self-organizing maps provided for the respective touching behavior classes.

The touching behavior classes are not completely independent of one another. In some cases, it is difficult to specify a single touching behavior using physical feature amounts detected for a certain control period. Most of recognition processes are context-dependent. In other words, since a touching behavior is recognized on the basis of a history in some cases, it is necessary to take transition data regarding the touching behavior into consideration. Accordingly, when a determination result regarding the presence or absence of each touching behavior on the corresponding self-organizing map for the touching behavior class is binarized to 0 or 1 and is then output, an identifier of the touching behavior determining section 133 determines a single touching behavior on the basis of priorities assigned to the respective classes and the transition data. Recognition of a plurality of touching behavior classes can also be performed without using the priorities.

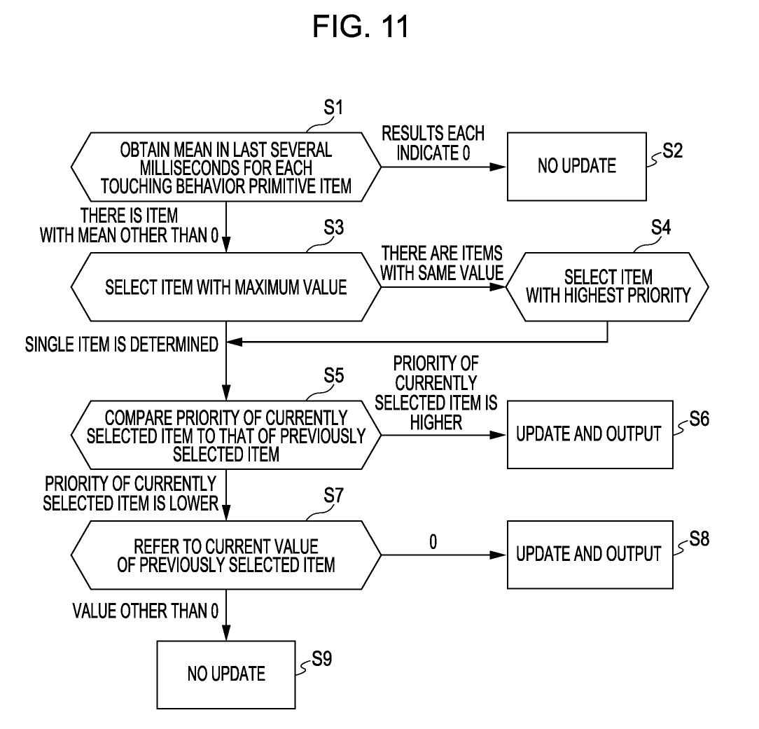

FIG. 11 is a flowchart of a process for determining a touching behavior on the basis of determination results regarding the presence or absence of each touching behavior by the touching behavior determining section 133.

First, a mean of determination results in the last several milliseconds is obtained for each touching behavior primitive item (step S1).

If the determination results on the respective touching behavior primitive items each indicate zero, recognition is not updated (step S2).

On the other hand, if the mean of the determination results on any touching behavior primitive item indicates a value other than zero, the item with a maximum value is selected (step S3). In this instance, if there are two or more items having the same value, the item assigned the highest priority is selected (step S4).

The priority assigned to the previously selected item is compared to that assigned to the currently selected item (step S5). If the priority assigned to the currently selected item is higher than that assigned to the previously selected item, recognition is updated and a result of recognition is output (step S6).

If the priority assigned to the currently selected item is lower than that assigned to the previously selected item, the current value of the previously selected item is referred to (step S7). If the value is zero, recognition is updated and a result of recognition is output (step S8). If the value is other than zero, recognition is not updated (step S9).

While the present invention has been described in detail by reference to a specific embodiment, it should be understood that modifications and substitutions thereof could be made by one skilled in the art without departing from the spirit and scope of the present invention.

The mechanism for touching behavior recognition described in this specification can be applied to a touch interaction with a robot in which tactile senses are distributed over the entire body surface (see FIG. 1). In this instance, if a system of the touching behavior recognition mechanism is included in a larger-scale system, the following application can be made. A target tactile sensor group to which attention should be paid and which touching behavior recognition output is obtained are determined on the basis of an output of another system. In the above-described embodiment, the self-organizing maps are used for identifying a touching behavior performed on each contact point group. The present inventor considers that continuous and multi-layered touching behaviors can be acquired using the hidden Markov model.

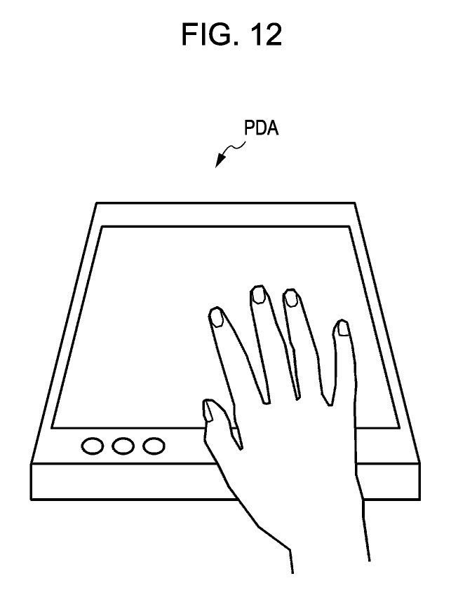

While the embodiment in which the present invention is applied to the bipedal walking type legged mobile robot has been mainly described in this specification, the spirit of the present invention is not limited to the embodiment. The present invention can be similarly applied to an apparatus that is operated on the basis of distinctive movements of fingers sensed through a touch detecting device. For example, the present invention is applicable to a touch panel personal digital assistant (PDA) which a user can operate by inputting coordinates with a single pen and can also operate by touching behaviors, i.e., touching with a plurality of fingertips (refer to FIG. 12).

The embodiments of the present invention have been described for illustrative purpose only, and the contents of the specification should not be interpreted restrictively. To understand the spirit and scope of the present invention, the appended claims should be taken into consideration.

The present application contains subject matter related to that disclosed in Japanese Priority Patent Application JP 2008-287793 filed in the Japan Patent Office on Nov. 10, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A touching behavior recognition apparatus comprising:
a contact point acquiring unit configured to acquire pressure information items and position information items in a plurality of contact points;
a clustering unit configured to perform clustering on the contact points on the basis of information regarding pressure deviations and position deviations of the contact points based on the information items acquired by the contact point acquiring unit to form contact point groups each including contact points associated with each other as a touching behavior; and
a touching behavior identifying unit configured to identify a touching behavior for each contact point group.

2. The apparatus according to claim 1, wherein the touching behavior identifying unit includes:
a feature amount calculating section configured to calculate N feature amounts from each contact point group, the feature amounts typifying a contact pattern, N being an integer of three or more;
a mapping section configured to map an N-dimensional feature amount calculated from each contact point group onto an n-dimensional space for each touching behavior class to determine the presence or absence of each touching behavior on the basis of mapped positions in the corresponding space, n being a positive integer less than N; and
a touching behavior determining section configured to determine a result of touching behavior recognition on each contact point on the basis of the mapped positions in the n-dimensional space.

3. The apparatus according to claim 2, wherein the mapping section converts the N-dimensional feature amount calculated from each contact point group into two-dimensional data using a learned hierarchical neural network.

4. The apparatus according to claim 2, wherein the mapping section converts the N-dimensional feature amount calculated from each contact point group into two-dimensional data using a learned self-organizing map.

5. The apparatus according to claim 2, wherein the mapping section provides the n-dimensional space for each touching behavior class intended to be identified, maps the N-dimensional feature amount calculated from each contact point group onto each of the n-dimensional spaces for the respective touching behavior classes, and determines the presence or absence of each touching behavior on the basis of the mapped positions in the corresponding space, and
the touching behavior determining section determines a single result of touching behavior recognition on each contact point group on the basis of transition data indicating results of determination regarding the presence or absence of each touching behavior on each contact point and priorities assigned to the respective touching behavior classes.

6. A method for touching behavior recognition, comprising the steps of:
acquiring pressure information items and position information items in a plurality of contact points;
performing clustering on the contact points on the basis of information regarding pressure deviations and position deviations of the contact points based on the acquired information items to form contact point groups each including contact points associated with each other as a touching behavior;
calculating N feature amounts from each contact point group, the feature amounts typifying a contact pattern, N being an integer of three or more;
providing an n-dimensional space for each touching behavior class intended to be identified and mapping an N-dimensional feature amount calculated from each contact point group onto each of the n-dimensional spaces for the respective touching behavior classes to determine the presence or absence of each touching behavior on the basis of mapped positions in the corresponding space, n being a positive integer less than N; and
determining a single result of touching behavior recognition on each contact point group on the basis of transition data indicating results of determination regarding the presence or absence of each touching behavior on each contact point and priorities assigned to the respective touching behavior classes.

7. An information processing apparatus for performing information processing in accordance with a user operation, the apparatus comprising:
a contact point detecting unit including tactile sensor groups attached to the main body of the information processing apparatus, the unit being configured to detect pressure information items and position information items in a plurality of contact points;
a clustering unit configured to perform clustering on the contact points on the basis of information regarding pressure deviations and position deviations of the contact points based on the information items detected by the contact point detecting unit to form contact point groups each including contact points associated with each other as a touching behavior;
a feature amount calculating unit configured to calculate N feature amounts from each contact point group, the feature amounts typifying a contact pattern, N being an integer of three or more;
a mapping unit configured to provide an n-dimensional space for each touching behavior class intended to be identified, map an N-dimensional feature amount calculated from each contact point group onto each of the n-dimensional spaces for the respective touching behavior classes, and determine the presence or absence of each touching behavior on the basis of mapped positions in the corresponding space;
a touching behavior determining unit configured to determine a single result of touching behavior recognition on each contact point group on the basis of transition data indicating results of determination regarding the presence or absence of each touching behavior on each contact point and priorities assigned to the respective touching behavior classes; and
a control unit configured to control information processing on the basis of the result of touching behavior recognition determined by the touching behavior determining unit.

8. A computer program described in computer-readable form so as to allow a computer to execute a process for recognizing a human touching behavior, the computer program allowing the computer to function as:
a contact point acquiring unit configured to acquire pressure information items and position information items in a plurality of contact points;
a clustering unit configured to perform clustering on the contact points on the basis of information regarding pressure deviations and position deviations of the contact points based on the information items acquired by the contact point acquiring unit to form contact point groups each including contact points associated with each other as a touching behavior;
a feature amount calculating unit configured to calculate N feature amounts from each contact point group, the feature amounts typifying a contact pattern, N being an integer of three or more;
a mapping unit configured to provide an n-dimensional space for each touching behavior class intended to be identified, map an N-dimensional feature amount calculated from each contact point group onto each of the n-dimensional spaces for the respective touching behavior classes, and determine the presence or absence of each touching behavior on the basis of mapped positions in the corresponding space;
a touching behavior determining unit configured to determine a single result of touching behavior recognition on each contact point group on the basis of transition data indicating results of determination regarding the presence or absence of each touching behavior on each contact point and priorities assigned to the respective touching behavior classes.
